(19) United States
(12) Patent Application Publication
(10) Pub. No.: US 2025/0231809 A1
(43) Pub. Date: Jul. 17, 2025

(54) POLYHEDRAL SCHEDULE COMPLETION MECHANISM RESPECTING USER REQUIREMENTS WITH A LOOK-AHEAD OPTIMIZATION

(71) Applicant: HUAWEI TECHNOLOGIES CO., LTD., Shenzhen (CN)

(72) Inventors: Jinman ZHAO, Kanata (CA); Kai-Ting Amy WANG, Kanata (CA); Yaoqing GAO, Kanata (CA)

(73) Assignee: HUAWEI TECHNOLOGIES CO., LTD., Shenzhen (CN)

(21) Appl. No.: 18/415,234

(22) Filed: Jan. 17, 2024

(51) Int. Cl. G06F 9/50

(52) U.S. Cl. CPC G06F 9/5038

(57) ABSTRACT

Methods and apparatus for completing schedules for computer program statements are disclosed. Primitive transformations applied to statement schedules to optimize a computer program can result in violations to the original dependencies between the respective statements. Embodiments of the present disclosure use a look-ahead mechanism to anticipate these violations when completing statement schedules. The look-ahead mechanism imposes conditions for solutions to a schedule row that strongly or weakly satisfy the dependency between the statements to avert violations caused by succeeding schedule rows. In some embodiments, a basis set depending from the program statements and primitives is maintained and used to determine schedule solutions. In some embodiments, the solutions for the schedules are determined to make the schedules full rank.

### CROSS-REFERENCE TO RELATED APPLICATIONS

This is the first application filed for the present invention.

### FIELD OF THE INVENTION

The present invention pertains to computing systems and in particular to a method for scheduling program statements.

### BACKGROUND

When executing a computer program, each statement of the program's algorithm must be mapped to machine resources in time and space. To improve computational performance, each statement can also be transformed according to a particular schedule. These transformations, namely schedule primitives, can be selected manually to fix particular entries of some statements' schedules to improve aspects of performance such as parallelization or locality. Examples of manual transformations include primitives for fusing, distributing, reordering, skewing, and tiling. Although manual transformations may be intended to improve the performance of the computer program, they can sometimes violate program semantics and lead to incorrect program code. In particular, conflicts due to dependencies between statements can arise, such as when a statement attempts to access a variable from memory before it has been written there (i.e., it violates a read-after-write dependency). Current approaches for enabling schedule primitives towards schedule completion are not able to validate and correct the schedules.

Therefore, there is a need for a method for schedule completion that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide methods and apparatus for schedule completion for computer program statements.

A first aspect of the present disclosure is to provide a method for schedule completion. The method may be performed by a computing device including a processor coupled to tangible, non-transitory processor-readable memory. The method may comprise receiving a computer program having a first statement and a second statement. The second statement may have a dependency on the first statement. The first statement may have associated thereto a first schedule, and the second statement may have associated thereto a second schedule. The first schedule and the second schedule may each have a respective plurality of rows, with each plurality of rows corresponding to a same plurality of dimensions. The method may further comprise, receiving one or more schedule primitives each defining a respective schedule modification, and modifying, in accordance with the one or more schedule primitives, the first schedule and the second schedule so that each row of the respective plurality of rows is either known or unknown. Each known row may be either constant or variable. The method may further comprise determining, for at least one dimension of the plurality of dimensions, when the corresponding row of at least one plurality of rows is unknown, when a next row of each plurality of rows is known and constant wherein the next row of each plurality of rows corresponds to a next dimension of the plurality of dimensions, and when the next row of the plurality of rows of the first schedule is lexically greater than the next row of the plurality of rows of the second schedule, a respective strong row solution for each unknown corresponding row of the first schedule and the second schedule. The strong row solutions may strongly satisfy the dependency of the second statement for the at least one dimension. The method may still further comprise generating an executable code from the computer program in accordance with each of the first schedule and the second schedule.

In some embodiments of the first aspect, the method may further comprise determining, for at least one other dimension of the plurality of dimensions, when the corresponding row of at least one plurality of rows is unknown, and when the next row of at least one plurality of rows is unknown, a respective weak row solution for each unknown corresponding row of the first schedule and the second schedule. In some other embodiments of the first aspect, the method may further comprise determining, for at least one other dimension of the plurality of dimensions, when the corresponding row of at least one plurality of rows is unknown, when the next row of each plurality of rows is known and constant, and when the next row of the plurality of rows of the first schedule is lexically less than or equal to the next row of the plurality of rows of the second schedule, a respective weak row solution for each unknown corresponding row of the first schedule and the second schedule. The weak row solutions may weakly satisfy the dependency of the second statement for the at least one other dimension.

In some embodiments of the first aspect, each of the first statement and the second statement may have a respective number of statement iterators, each of the first schedule and the second schedule may have a respective schedule rank associated thereto, and at least one of the first schedule and the second schedule may have a respective number of unknown rows of the respective plurality of rows. In some embodiments, determining, for the at least one dimension of the plurality of dimensions, the respective strong row solution for the corresponding row of each of the first schedule and the second schedule, includes determining the respective strong row solution for each unknown corresponding row of the first schedule and the second schedule to increase the respective schedule rank when the respective number of unknown rows equals a respective difference comprising the respective number of statement iterators and the respective schedule rank. In some embodiments, determining, for the at least one other dimension of the plurality of dimensions, the respective weak row solution for the corresponding row of each of the first schedule and the second schedule, includes determining the respective weak row solution for each unknown corresponding row of the first schedule and the second schedule to increase the respective schedule rank when the respective number of unknown rows equals a difference comprising the respective number of statement iterators and the respective schedule rank.

In some embodiments of the first aspect, the dependency of the second statement on the first statement may define a dependence polyhedron representing one or more iterator dependences. In these embodiments, the method may further comprise updating, when the respective strong row solution for each unknown corresponding row of the first schedule and the second schedule is determined for the at least one dimension of the plurality of dimensions, the dependence polyhedron in accordance with each of the strong row solutions to remove at least one iterator dependence of the one or more iterator dependences.

In some embodiments of the first aspect, the computer program may include one or more iterators and one or more symbols, each of the first statement and the second statement may include a respective set of iterators from the one or more iterators and a respective set of symbols from the one or more symbols, and each of the first statement and the second statement may have associated thereto a respective statement basis comprising a respective plurality of basis items depending from at least one of the respective set of iterators, the respective set of symbols, and the one or more schedule primitives. In these embodiments, each row solution may be a respective linear combination comprising one or more basis items of the respective plurality of basis items. In some embodiments, each of the first schedule and the second schedule may have a respective schedule rank associated thereto, and the method may further comprise, updating, for at least one of the first schedule and the second schedule, when the respective row solution is determined for the at least one dimension of the plurality of dimensions and when the respective row solution increases the respective schedule rank, the respective statement basis in accordance with the respective row solution. In some embodiments, each of the first schedule and the second schedule may have a respective schedule rank associated thereto, and each basis item of the respective statement basis of the first statement and the second statement may have associated thereto a respective position of a plurality of positions in the respective statement basis. The plurality of positions may extend from a beginning of the respective statement basis to an end of the respective statement basis. In these embodiments, the method may further comprise: removing, for at least one of the first schedule and the second schedule, when the respective row solution is determined for the at least one dimension of the plurality of dimensions and when the respective row solution increases the respective schedule rank, one basis item of the respective statement basis from the respective statement basis, wherein the position of the one basis item corresponds to the increased respective schedule rank; and inserting, for at least one of the first schedule and the second schedule, when the one basis item of the respective statement basis is removed, a new basis item into the respective statement basis in accordance with the respective row solution, wherein the new basis item has associated thereto a position in the respective statement basis corresponding to the beginning of the respective statement basis. In some embodiments, for each of the first statement and the second statement, the respective plurality of basis items may include each known row of the respective plurality of rows. In some embodiments, for each of the first statement and the second statement, the respective statement basis may indicate a respective preferred order of the respective set of iterators and each row solution may be determined in accordance with the respective preferred order.

In some embodiments of the first aspect, the computer program may include one or more iterators and one or more symbols, each of the first statement and the second statement may include a respective set of iterators from the one or more iterators and a respective set of symbols from the one or more symbols, and each of the first statement and the second statement may have associated thereto a respective statement basis comprising a respective plurality of basis items depending from at least one of the respective set of iterators, the respective set of symbols, and the one or more schedule primitives. In these embodiments, the method may further comprise determining, for the first schedule, a respective schedule rank in accordance with the statement basis of the first statement and, for the second schedule, a respective schedule rank in accordance with the statement basis of the second statement.

In some embodiments of the first aspect, determining, for the at least one dimension of the plurality of dimensions, the respective strong row solution for the corresponding row of each of the first schedule and the second schedule may include using an integer linear programming solver.

In some embodiments of the first aspect, determining, for the at least one dimension of the plurality of dimensions, the respective strong row solution for the corresponding row of each of the first schedule and the second schedule includes applying Farkas' lemma.

In some embodiments of the first aspect, the dependency of the second statement on the first statement includes at least one of a flow dependence, an anti-dependence, an input dependence, and an output dependence.

In some embodiments of the first aspect, the computer program may be a linear computer program.

In some embodiments of the first aspect, each of the first schedule and the second schedule may be represented by a respective affine function.

In some embodiments of the first aspect, at least one schedule modification defined by one of the one or more schedule primitives may be for one of fusing, skewing, distributing, tiling, reordering, and strip mining.

A second aspect of the present disclosure is to provide a computing device comprising a processor coupled to tangible, non-transitory processor-readable memory. The memory may have stored thereon instructions to be executed by the processor to implement the method of the first aspect or any variations depending therefrom.

A third aspect of the present disclosure is to provide a tangible, non-transitory processor-readable memory having stored thereon instructions to be executed by a processor to implement the method of the first aspect or any variations depending therefrom.

Embodiments have been described above in conjunctions with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1A shows an example of iteration domains for a first statement and a dependent, second statement of a computer program, where embodiments according to the present disclosure may be implemented.

FIG. 1B shows an example of iteration domains for a first statement and a dependent, second statement of a computer program, where a fuse primitive has violated the dependency.

FIG. 1C shows an example of iteration domains for a first statement and a dependent, second statement of a computer program, where a fuse primitive and reorder primitive have violated the dependency.

FIG. 2 shows a flowchart of a method for schedule completion according to an embodiment of the present disclosure.

FIG. 3A shows an example of iteration domains for a first statement and a dependent, second statement of a computer program, where statement schedules have been completed by a method in accordance with the present disclosure.

FIG. 3B shows an example of iteration domains for a first statement and a dependent, second statement of a computer program, where statement schedules have been completed by a method in accordance with the present disclosure.

FIG. 4 shows a schematic of an apparatus for schedule completion according to embodiments of the present disclosure.

FIG. 5 shows a schematic of an embodiment of an electronic device that may implement at least part of the methods and features of the present disclosure.

It will be noted that throughout the appended drawings, like features are identified by like reference numerals.

### DETAILED DESCRIPTION

To improve schedule completion for computer program statements, embodiments of the present disclosure are generally directed towards providing a look-ahead mechanism for detecting dependency conflicts and modifying statement schedules accordingly. Methods embodying the look-ahead mechanism may involve modifying interdependent statement schedules in accordance with user-provided primitives and determining solutions for the schedules that anticipate dependency conflicts resulting from the primitives. In some embodiments, the solutions may be determined as a linear combination of items belonging to a basis depending from the program statements and the primitives. In some embodiments, the solutions for the schedules may be determined to make the schedules full rank. In some embodiments, the dependence between the statement schedules may define a dependence polyhedron that may be updated throughout schedule completion in accordance with solutions determined for the schedules.

The present disclosure sets forth various embodiments via the use of block diagrams, flowcharts, and examples. Insofar as such block diagrams, flowcharts, and examples contain one or more functions and/or operations, it will be understood by a person skilled in the art that each function and/or operation within such block diagrams, flowcharts, and examples can be implemented, individually or collectively, by a wide range of hardware, software, firmware, or combination thereof. As used herein, the term “about” should be read as including variation from the nominal value, for example, a +/−10% variation from the nominal value. It is to be understood that such a variation is always included in a given value provided herein, whether or not it is specifically referred to.

The schedule θ for a statement S of a computer program, particularly a linear program, may be defined according to an affine function of the statement's vector of iterators Is and the vector of symbols p:

$${θ}_{S} ( \vec{{l}_{S}} , \vec{p} ) = {T}_{S} [ \vec{{l}_{S}} ] + {W}_{S} [ \begin{matrix}\vec{p} \\ 1\end{matrix} ] \qquad ( 1 )$$

where T_{S} and W_{S} are matrices that can be computed to complete the schedule. The dependency between a first statement (i.e., a source statement, src) of the computer program and a second, dependant statement (i.e., a destination statement, dst) of the computer program can be represented by a non-empty dependence polyhedron [symbol] _{(src,dst)}. The dependency may, for example, include a flow dependence, an anti dependence, an input dependence, an output dependence, or a combination thereof. To preserve the dependency between the first statement and the second statement, the respective schedules associated with each statement must ensure that the first statement is executed lexically before (i.e., is lexically less than) the second statement for each integer instance (\hat{x}, ŷ) of iterators inside the dependence polyhedron:

$$∀ ( \vec{x} , \vec{y} ) ∈ {𝒫}_{( src , dst )} , {θ}_{src} ( \vec{x} , \vec{p} ) \leq {θ}_{dst} ( \vec{y} , \vec{p} ) \qquad ( 2 )$$

If, for an i^{th} dimension of the schedules, θ_{src}(\hat{x},\hat{p})[i]<θ_{dst}(ŷ,\hat{p})[i], the schedules are said to strongly satisfy the dependence relation. However, if θ_{src}(\hat{x},\hat{p})[i]≤θ_{dst}(ŷ,\hat{p})[i], the schedules are said to weakly satisfy the dependence relation. If Equation 2 does not hold true, the dependency is said to be violated and the program semantics may be incorrect.

The computer program may have opportunities for optimization during compilation. The program can be optimized through schedule primitives that transform the initial schedules of program statements (i.e., the candidate schedules) and that can result in certain entries in a schedule being fixed; for example, primitives for fusing, distributing, reordering, skewing, tiling, or a combination thereof can be applied to the schedules. Example 1 below shows program code with statements S1 and S2, where n and m are iterators bounded by symbols N and M.

### Example 1

| for n = 1 to N: | |
|---|---|
| for m = 1 to M: | |
| A[m] = 0.33*(B[m−1] + B[m] + B[m+1]) | //S1 |
| for m = 1 to M: | |
| B[m] = 0.33*(A[m−1] + A[m] + A[m+1]) | //S2 |

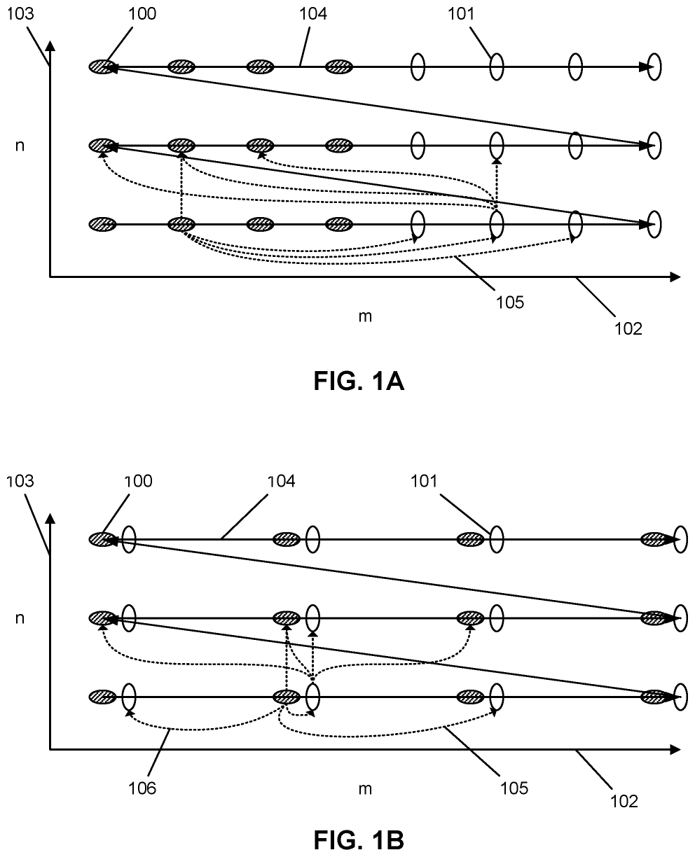

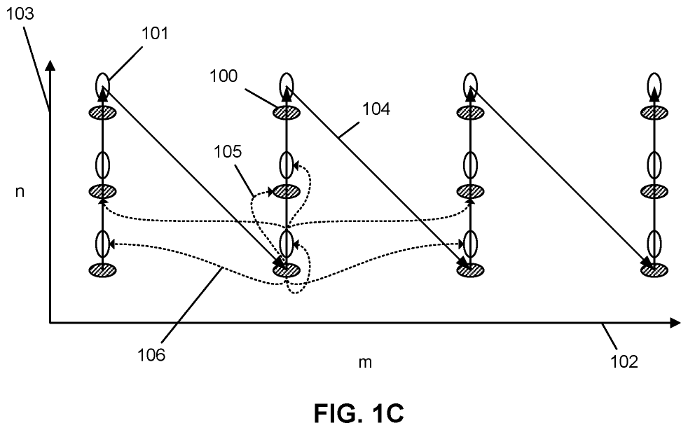

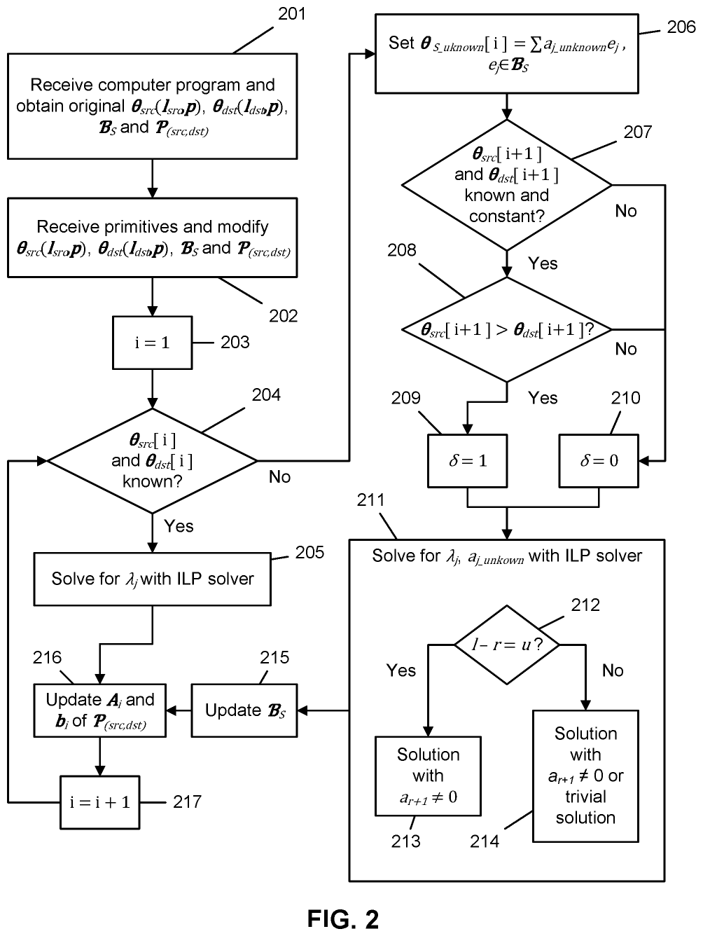

FIG. 1A shows the S1 iteration domain 100 (shaded ellipses) and the S2 iteration domain 101 (plain ellipses) for Example 1 over iterator m 102 and iterator n 103, with the execution order 104 (solid arrow) and a selection of dependences 105 (dotted arrows) for the statements shown as well. When a fuse (m,m) primitive is applied to the program code of Example 1, entries of the schedules for statements S1 and S2, θ_{S1} and θ_{S2} respectively, following Equation 1, become fixed:

$${θ}_{S 1} ( \vec{{l}_{S 1}} , \vec{p} ) = [ \begin{matrix}* \\ 0 \\ * \\ 0\end{matrix} ] = [ \begin{matrix}* & * \\ 0 & 0 \\ * & * \\ 0 & 0\end{matrix} ] [ \begin{matrix}n \\ m\end{matrix} ] + [ \begin{matrix}* & * & * \\ 0 & 0 & 0 \\ * & * & * \\ 0 & 0 & 0\end{matrix} ] [ \begin{matrix}N \\ M \\ 1\end{matrix} ] \qquad ( 3 )$$

$${θ}_{S 2} ( \vec{{l}_{S 2}} , \vec{p} ) = [ \begin{matrix}* \\ 0 \\ * \\ 1\end{matrix} ] = [ \begin{matrix}* & * \\ 0 & 0 \\ * & * \\ 0 & 0\end{matrix} ] [ \begin{matrix}n \\ m\end{matrix} ] + [ \begin{matrix}* & * & * \\ 0 & 0 & 0 \\ * & * & * \\ 0 & 0 & 1\end{matrix} ] [ \begin{matrix}N \\ M \\ 1\end{matrix} ] \qquad ( 4 )$$

where * indicates entries of the schedule that are yet to be completed (i.e., they are unknown).

Each schedule can further have associated with it a basis set (referred to herein as a “respective basis”) that indicates a preference for ordering of loop variables and that can be modified in optimizing the program as well. For example, the statements of the original code of Example 1 would have a basis of [symbol] ₛ={n, m, N, M, 1}. If the fuse (m,m) primitive and then a reorder(n,m) primitive were to be applied to Example 1, the basis could then become [symbol] ₛ={m, n, N, M, 1}. Alternatively, if the fuse (m,m) primitive and then a skew ([n,m],1,[0,1]) primitive were to be applied to Example 1, the basis could become [symbol] ₛ={n,m+n,N,M,1}.

In some cases, optimizations applied by primitives can lead to statement schedules that violate the dependency of the original code and that lead to incorrect program semantics. For Example 1 with fuse(m,m) applied and [symbol] ₛ={n,m,N,M,1}, θ_{S1}(\vec{l_{S1}},\vec{p})=[n, 0, m, 0] and θ_{S2}(\vec{l_{S2}},\vec{p})=[n, 0, m, 1], which has violations to the dependency between S1 and S2. FIG. 1B shows the changes in this case to the iteration domain S1 100 and the iteration domain S2 as well as the execution order 104 and dependences 105. FIG. 1B further shows some violations 106 to the dependency, which are shown as dependences that are directed against the execution order 104. For Example 1 with fuse (m,m) and then reorder (n,m) applied and [symbol] ₛ={n, m+n, N, M, 1}, θ_{S1}(\vec{l_{S1}},\vec{p})=[m, 0, n, 0] and θ_{S2}(\vec{l_{S2}},\vec{p})=[m, 0, n, 1], which also have violations to the dependency. FIG. 1C shows the changes in this case to the iteration domain S1 100 and the iteration domain S2 as well as the execution order 104 and dependences 105. Like FIG. 1B, FIG. 1C shows violations 106 to the dependency.

Embodiments of the present disclosure may enable computer programs to be optimized through schedule primitives while still preserving program semantics by anticipating dependency violations through a look-ahead mechanism when the program's statement schedules are being completed.

For a statement schedule to be valid, the submatrix T′_{S} of matrix T_{S} having its non-zero rows must be invertible, or more precisely, the submatrix T′_{S} must be full rank. If a statement has l surrounding loop iterators in the computer program, the respective schedule must have l entries that involve loop iterators, and thus the submatrix T′ₛ must be of size l×l with a rank of l. An example of valid, complete schedule could be:

$${θ}_{S} ( \vec{{l}_{S}} , \vec{p} ) = [ \begin{matrix}n + m \\ 0 \\ m \\ 0\end{matrix} ] = [ \begin{matrix}1 & 1 \\ 0 & 0 \\ 0 & 1 \\ 0 & 0\end{matrix} ] [ \begin{matrix}n \\ m\end{matrix} ] + [ \begin{matrix}0 & 0 & 0 \\ 0 & 0 & 0 \\ 0 & 0 & 0 \\ 0 & 0 & 1\end{matrix} ] [ \begin{matrix}N \\ M \\ 1\end{matrix} ] , {{T}^{′}}_{S} = [ \begin{matrix}1 & 1 \\ 0 & 1\end{matrix} ]$$

where T′ₛ is full rank (rank=2) and thus invertible. When completing the rows of a schedule, if submatrix T′ₛ achieves full rank, then any unknown rows can be completed with entries of zero because there is no need to further increase the rank. If submatrix T′ₛ is not yet full rank, an unknown row must be completed with a solution having at least one non-zero entry and the solution must be linearly independent from the known rows to increase the rank of T′ₛ.

Unknown rows for an i^{th} dimension of respective schedules for a first statement and a dependent, second statement can be solved using the following equation, derived by applying Farkas' lemma to Equation 2:

$$\{ \begin{matrix}{θ}_{dst} ( \vec{y} , \vec{p} ) [ i ] - {θ}_{src} ( \vec{x} , \vec{p} ) [ i ] - δ = {λ}_{0} + \vec{λ} ( {A}_{i} [ \begin{matrix}\vec{x} \\ \vec{y}\end{matrix} ] + \vec{{b}_{ι}} ) \\ {λ}_{j} \geq 0\end{matrix} \qquad ( 5 )$$

where δ can be set to 1 or 0 to impose strong or weak satisfaction of the dependency, Aᵢ and \vec{b_{ι}} define the constrained space of the dependence polyhedron [symbol] _{(src,dst)}, and the coefficients λⱼ of \vec{λ} are solvable quantities. If a solution exists for the coefficients λⱼ, then the dependency will be satisfied by the schedules.

Embodiments of the present disclosure may complete unknown rows of a first statement schedule and a dependent, second schedule by solving Equation 5, while keeping known rows, such as those fixed by a schedule primitive, unchanged. In embodiments, the solution for an unknown row at the i^{th} dimension of the first statement schedule or second statement schedule may be determined after inspecting the succeeding rows of each schedule for a dependency violation according to Equation 2. The violation can then be anticipated and avoided by setting the variable δ to 1 in Equation 5 to impose a solution that strongly satisfies the dependency. In embodiments, the solutions for unknown rows may further be determined to maintain preferences for the ordering of iterators as indicated by the basis set for a statement. The basis set may further be updated and used towards determining solutions for unknown rows and for increasing the rank of the submatrices T′ₛ.

FIG. 2 shows a flowchart of a method for schedule completion for a computer program, in accordance with an embodiment of the present disclosure. The computer program may, in particular, be a linear computer program. The computer program may have a first statement and a second statement, with the second statement having a dependency on the first statement. The dependency may include one or more iterator dependences, such as a flow dependence, an anti dependence, an input dependence, an output dependence, or a combination thereof. The first statement and the second statement may have associated with them a first schedule θ_{src}(\vec{l_{src}},\vec{p}) and a second schedule θ_{dst}(\vec{l_{dst}},\vec{p}), respectively. Each of the first schedule and the second schedule may have a respective plurality of rows corresponding to a same plurality of dimensions (defined by index [i]). Each of the first schedule and the second schedule may be representable by an affine function, such as that of Equation 1. The computer program may include one or more iterators and one or more symbols, with each of the first statement and the second statement including a respective set of l iterators from the one or more iterators and a respective set of symbols from the one or more symbols.

At action 201, the computer program may be received, and the first schedule and the second schedule may be obtained. A respective basis [symbol] ₛ as well as a dependence polyhedron [symbol] _{(src,dst)} for the first statement and the second statement may also be obtained from the computer program. Each respective basis of the first statement and the second statement may comprise a respective plurality of basis items e; depending from at least one of the respective set of iterators and the respective set of symbols. For example, the initial basis for each of the statements could be [symbol] ₛ={\vec{lₛ}, \vec{p}, 1}={n, m, k, N, M, L, 1} if the computer program has three iterators (n, m, k) and three symbols (N, M, L).

At action 202, one or more schedule primitives may be received and the first schedule, second schedule, their respective bases, and the dependence polyhedron may be modified accordingly. Each schedule primitive may describe a respective schedule modification and may, for example, be a primitive for fusing, skewing, distributing, tiling, reordering, or strip mining. Modifications to each basis may indicate a preferred order for the respective set of iterators. The dependence polyhedron may need to be updated, for example, to reflect a change of name in a variable such as from fusing or to reflect an addition of a new variable such as from strip mining. In modifying the first schedule and the second schedule, each row of the respective plurality of rows may become either known (i.e., fixed by a primitive) or unknown. If a row is known, it may either be constant (e.g., 0 or 1) or variable (e.g., n+m). With some rows known, the respective schedule may have associated with it a respective rank r, indicating a number of linearly independent rows in the respective schedule, and a respective number of unknown rows u. The values of r and u for a schedule may be determined from the respective basis. An example of a modified schedule with some known row entries could be:

$${θ}_{S} ( \vec{{l}_{S}} , \vec{p} ) = [ \begin{matrix}n + m \\ * \\ * \\ k \\ *\end{matrix} ]$$

The basis for this example could also be specified as [symbol] ₛ={n+m, k, m, N, M, L, 1}, which could be a modification of [symbol] ₛ={n, m, k, N, M, L, 1} where n has been replaced with n+m and k has been moved forward. In this case, r=2, u=2, and l=3, such that there are two opportunities in completing the schedule to make T′ₛ full rank.

At action 203, completion of the first schedule and second schedule may begin with the index i for the plurality of dimensions being initialized to one (i.e., completion may begin with the first rows of the first and second schedules, and may proceed sequentially). Schedule completion of an i^{th} dimension will generally be achieved by solving Equation 5.

At action 204, the respective rows of the first schedule and the second schedule corresponding to the i^{th} dimension (i.e., θ_{src}[i] and θ_{dst}[i]) may be assessed to determine whether they are known or unknown. If both respective rows of the first schedule and the second schedule are known, schedule completion may proceed through action 205. If, however, at least one of the respective rows of the first schedule and the second schedule are unknown, then schedule completion may proceed through action 206.

At action 205, with θ_{src}[i] and θ_{dst}[i] known, & may be set to 0 in Equation 5 and solutions for λⱼ may be determined using Equation 5. An integer linear programming (ILP) solver may be used in solving Equation 5. Schedule completion may then proceed through action 216.

At action 206, with at least one of θ_{src}[i] and θ_{dst}[i] unknown, each unknown row (i.e., θ_{S_unknown}[i]) may be set to be a linear combination of the respective plurality of basis items:

$${θ}_{S \_ unknown} [ i ] = {\sum }_{{e}_{j} ϵ {B}_{S}} {a}_{j \_ unknown} {e}_{j} \qquad ( 6 )$$

where a_{j_unknown} are solvable coefficients defining the linear combination. At action 207, the respective rows of the first schedule and the second schedule corresponding to the i+1^{th} dimension (i.e., the “next” or succeeding rows, θ_{src}[i+1] and θ_{dst}[i+1]) may be assessed to determine whether they are known or unknown, and if known, whether they are constant. If both θ_{src}[i+1] and θ_{dst}[i+1] are known and constant, then these rows may be assessed for a dependency violation using Equation 2, at action 208. If both θ_{src}[i+1] and θ_{dst}[i+1] are known and constant and a dependency violation occurs between these rows, then & may be set to 1 in Equation 5, at action 209, to impose a strong row solution for each θ_{S_unknown}[i]. If, however, at least one of θ_{src}[i+1] and θ_{dst}[i+1] is unknown or is known and variable, or if both θ_{src}[i+1] and θ_{dst}[i+1] are known and constant and a dependency violation does not occur between these rows, then 8 may be set to 0 in Equation 5, at action 209, to impose a weak row solution for each θ_{S_unknown}[i]. At action 211, a row solution for each θ_{S_unknown}[i] may be determined. This may include determining the a_{j_unknown} and λⱼ with Equation 5, and may include using an ILP solver. Each row solution may be determined in accordance with the respective schedule's current rank, number of unknown rows, and number of iterators. At sub-action 212, the quantity l−r may be evaluated for whether it equals u. If l−r=u, the row solution may be determined, at sub-action 213, to increase the respective schedule's rank by finding a solution where aᵣ₊₁ is nonzero. If l−r≠u (i.e., l−r<u), then any row solution may be determined, including a trivial solution such as 0 or 1, at sub-action 214. For action 211, constraints may not be placed on the values for a_{j_unknown} where j>l and the coefficients correspond to symbols in the respective basis.

At action 215, the respective basis for each of the first statement and the second statement may be updated in accordance with the respective row solution determined at action 211. In particular, if the solution for aᵣ₊₁ is nonzero, the respective rank of each statement schedule may be incremented, the r^{th} item may be removed from the respective basis, and a₁e₁+ . . . +aₗeₗ are may be placed at the beginning of the basis. The respective number of unknowns may be similarly decremented if a row solution for an unknown row was determined.

At action 216, the dependence polyhedron, represented by Aᵢ and \vec{b_{ι}}, may be updated in accordance with the strong row solutions determined for unknown rows. Updating the dependence polyhedron may include removing at least one of the iterator dependences. Removal of dependences that have been strongly satisfied may broaden the solution space for succeeding rows in the schedules.

At action 217, the dimensional index i may be incremented such that schedule completion proceeds for the next rows of the first schedule and the second schedule. Actions 204 to 216 may be performed for each dimension of the plurality of dimensions to complete every row of the first schedule and the second schedule.

In some embodiments, the method of FIG. 2 may further include generating and executing an executable code in accordance with each of the completed first schedule and the completed second schedule.

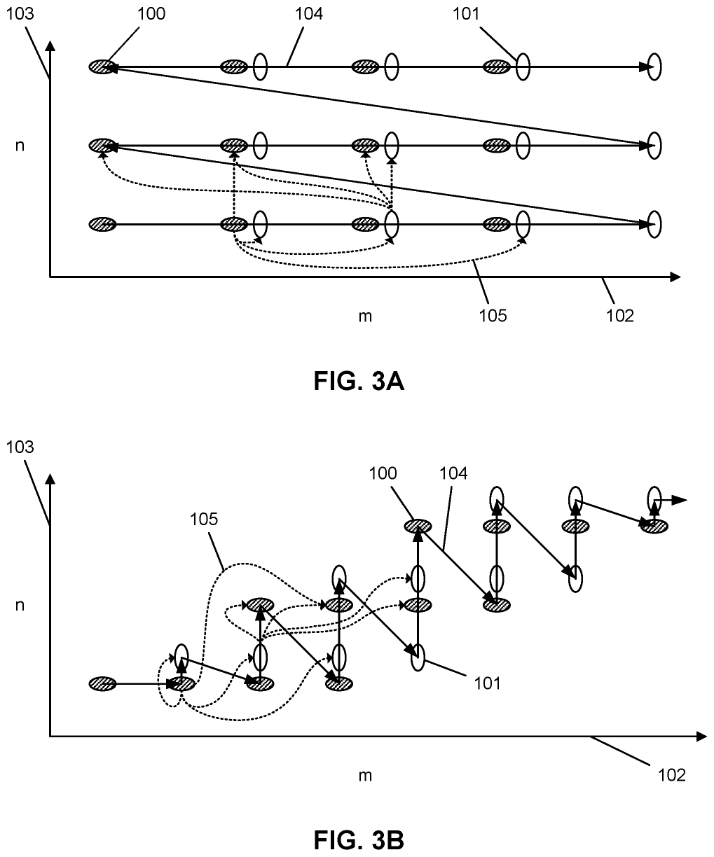

FIG. 3A shows the S1 iteration domain 100 and the S2 iteration domain 101 for Example 1 with fuse (m,m) applied, like FIG. 1B, but with schedules solved in accordance with the method of FIG. 2. The completed schedules in this case are θ_{S1} (\vec{l_{S1}},\vec{p})=[n, 0, m, 0] and θ_{S2}(\vec{l_{S2}},\vec{p})=[n, 0, m+1, 1], which result in dependences 105 that satisfy the dependency between S1 and S2. FIG. 3B shows the S1 iteration domain 100 and the S2 iteration domain 101 for Example 1 with fuse (m,m) and then reorder (n,m) applied, like FIG. 1C, but with schedules solved in accordance with the method of FIG. 2. The completed schedules in this case are θ_{S1}(\vec{l_{S1}},\vec{p})=[2n+m, 0, n, 0] and θ_{S2}(\vec{l_{S2}},\vec{p})=[2n+m+1, 0, n, 1], which result in dependences 105 that satisfy the dependency between S1 and S2.

Embodiments of the present disclosure may be implemented using electronics hardware, software, or a combination thereof. In some embodiments, the invention may be implemented by one or multiple computer processors executing program instructions stored in memory. In some embodiments, the invention may be implemented partially or fully in hardware, for example using one or more field programmable gate arrays (FPGAs) or application specific integrated circuits (ASICs) to rapidly perform processing operations.

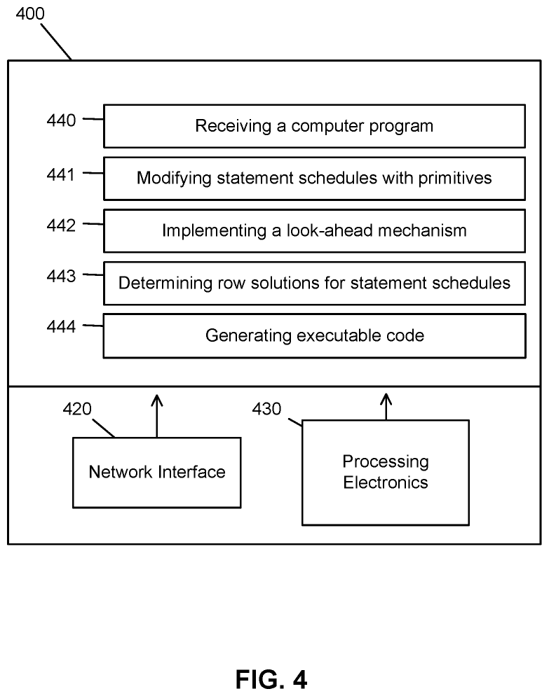

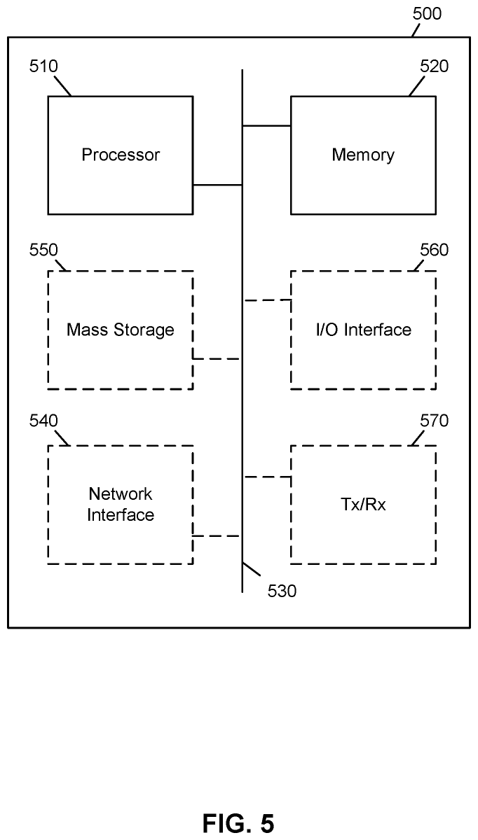

FIG. 4 shows an apparatus 400 for schedule completion, according to embodiments of the present invention. The apparatus may include a network interface 420 and processing electronics 430. The processing electronics may include a computer processor executing program instructions stored in memory, or other electronics components such as digital circuitry, including for example FPGAs and ASICs. The network interface may include an optical communication interface or radio communication interface, such as a transmitter and receiver. The apparatus may include several functional components, each of which is partially or fully implemented using the underlying network interface 420 and processing electronics 430. Examples of functional components may include modules for receiving 440 a computer program, modifying 441 statement schedules with primitives, implementing 442 a look-ahead mechanism, determining 443 row solutions for statement schedules, and generating 444 executable code.

FIG. 5 shows a schematic diagram of an electronic device 500 that may perform any or all of the operations of the above methods and features explicitly or implicitly described herein, according to different embodiments of the present disclosure. For example, a computer equipped to complete program schedules may be configured as electronic device 500. The electronic device 500 may be used to implement the apparatus 400 of FIG. 4, for example.

As shown, the electronic device 500 may include a processor 510, such as a Central Processing Unit (CPU) or specialized processors such as a Graphics Processing Unit (GPU) or other such processor unit, memory 520, and a bi-directional bus 530 to communicatively couple the components of electronic device 500. Electronic device 500 may also optionally include a network interface 540, non-transitory mass storage 550, an I/O interface 560, and a transceiver 570. According to certain embodiments, any or all of the depicted elements may be utilized, or only a subset of the elements. Further, the electronic device 500 may contain multiple instances of certain elements, such as multiple processors, memories, or transceivers. Also, elements of the hardware device may be directly coupled to other elements without the bi-directional bus 530. Additionally or alternatively to a processor and memory, other electronics, such as integrated circuits, may be employed for performing the required logical operations.

The memory 520 may include any type of non-transitory memory such as static random access memory (SRAM), dynamic random access memory (DRAM), synchronous DRAM (SDRAM), read-only memory (ROM), any combination of such, or the like. The mass storage element 550 may include any type of non-transitory storage device, such as a solid state drive, hard disk drive, a magnetic disk drive, an optical disk drive, USB drive, or any computer program product configured to store data and machine executable program code. According to certain embodiments, the memory 520 or mass storage 550 may have recorded thereon statements and instructions executable by the processor 510 for performing any of the aforementioned method operations described above.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product may include a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via an electronic element depending on the particular context. The term “and/or” herein when used in association with a list of items means any one or more of the items comprising that list.

Although a combination of features is shown in the illustrated embodiments, not all of them need to be combined to realize the benefits of various embodiments of this disclosure. In other words, a system or method designed according to an embodiment of this disclosure will not necessarily include all features shown in any one of the Figures or all portions schematically shown in the Figures. Moreover, selected features of one example embodiment may be combined with selected features of other example embodiments.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method comprising, by a computing device including a processor coupled to tangible, non-transitory processor-readable memory:
receiving a computer program having a first statement and a second statement, the second statement having a dependency on the first statement, the first statement having associated thereto a first schedule, the second statement having associated thereto a second schedule, the first schedule and the second schedule each having a respective plurality of rows, each plurality of rows corresponding to a same plurality of dimensions;
receiving one or more schedule primitives each defining a respective schedule modification;
modifying, in accordance with the one or more schedule primitives, the first schedule and the second schedule so that each row of the respective plurality of rows is either known or unknown, each known row being either constant or variable;
determining, for at least one dimension of the plurality of dimensions:
when the corresponding row of at least one plurality of rows is unknown,
when a next row of each plurality of rows is known and constant, the next row of each plurality of rows corresponding to a next dimension of the plurality of dimensions,
and
when the next row of the plurality of rows of the first schedule is lexically greater than the next row of the plurality of rows of the second schedule,
a respective strong row solution for each unknown corresponding row of the first schedule and the second schedule, the strong row solutions strongly satisfying the dependency of the second statement for the at least one dimension;
and
generating an executable code from the computer program in accordance with each of the first schedule and the second schedule.

2. The method of claim 1 further comprising, by the computing device:
determining, for at least one other dimension of the plurality of dimensions:
when the corresponding row of at least one plurality of rows is unknown,
and
when the next row of at least one plurality of rows is unknown,
a respective weak row solution for each unknown corresponding row of the first schedule and the second schedule, the weak row solutions weakly satisfying the dependency of the second statement for the at least one other dimension.

3. The method of claim 1 further comprising, by the computing device:
determining, for at least one other dimension of the plurality of dimensions:
when the corresponding row of at least one plurality of rows is unknown,
when the next row of each plurality of rows is known and constant,
and
when the next row of the plurality of rows of the first schedule is lexically less than or equal to the next row of the plurality of rows of the second schedule,
a respective weak row solution for each unknown corresponding row of the first schedule and the second schedule, the weak row solutions weakly satisfying the dependency of the second statement for the at least one other dimension.

4. The method of claim 1 wherein:
each of the first statement and the second statement has a respective number of statement iterators;
each of the first schedule and the second schedule has a respective schedule rank associated thereto;
at least one of the first schedule and the second schedule has a respective number of unknown rows of the respective plurality of rows;
and
determining, for the at least one dimension of the plurality of dimensions:
when the corresponding row of at least one plurality of rows is unknown,
when the next row of each plurality of rows is known and constant,
and
when the next row of the plurality of rows of the first schedule is lexically greater than the next row of the plurality of rows of the second schedule,
the respective strong row solution for the corresponding row of each of the first schedule and the second schedule,
includes:
determining the respective strong row solution for each unknown corresponding row of the first schedule and the second schedule to increase the respective schedule rank when the respective number of unknown rows equals a respective difference comprising the respective number of statement iterators and the respective schedule rank.

5. The method of claim 2 wherein:
each of the first statement and the second statement has a respective number of statement iterators;
each of the first schedule and the second schedule has a respective schedule rank associated thereto;
at least one of the first schedule and the second schedule has a respective number of unknown rows of the respective plurality of rows;
and
determining, for the at least one other dimension of the plurality of dimensions:
when the corresponding row of at least one plurality of rows is unknown,
and
when the next row of at least one plurality of rows is unknown,
the respective weak row solution for the corresponding row of each of the first schedule and the second schedule,
includes:
determining the respective weak row solution for each unknown corresponding row of the first schedule and the second schedule to increase the respective schedule rank when the respective number of unknown rows equals a difference comprising the respective number of statement iterators and the respective schedule rank.

6. The method of claim 3 wherein:
each of the first statement and the second statement has a respective number of statement iterators;
each of the first schedule and the second schedule has a respective schedule rank associated thereto;
at least one of the first schedule and the second schedule has a respective number of unknown rows of the respective plurality of rows;
and
determining, for the at least one other dimension of the plurality of dimensions:
when the corresponding row of at least one plurality of rows is unknown,
and
when the next row of each plurality of rows is known and constant,
the respective weak row solution for the corresponding row of each of the first schedule and the second schedule,
includes:
determining the respective weak row solution for each unknown corresponding row of the first schedule and the second schedule to increase the respective schedule rank when the respective number of unknown rows equals a difference comprising the respective number of statement iterators and the respective schedule rank.

7. The method of claim 1 wherein:
the dependency of the second statement on the first statement defines a dependence polyhedron representing one or more iterator dependences;
and
the method further comprises, by the computing device:
updating, when the respective strong row solution for each unknown corresponding row of the first schedule and the second schedule is determined for the at least one dimension of the plurality of dimensions, the dependence polyhedron in accordance with each of the strong row solutions to remove at least one iterator dependence of the one or more iterator dependences.

8. The method of claim 1 wherein:
the computer program includes one or more iterators and one or more symbols;
each of the first statement and the second statement includes a respective set of iterators from the one or more iterators and a respective set of symbols from the one or more symbols;
each of the first statement and the second statement has associated thereto a respective statement basis comprising a respective plurality of basis items depending from at least one of the respective set of iterators, the respective set of symbols, and the one or more schedule primitives;
and
each strong row solution is a respective linear combination comprising one or more basis items of the respective plurality of basis items.

9. The method of any one of claim 2 or 3 wherein:
the computer program includes one or more iterators and one or more symbols;
each of the first statement and the second statement includes a respective set of iterators from the one or more iterators and a respective set of symbols from the one or more symbols;
each of the first statement and the second statement has associated thereto a respective statement basis comprising a respective plurality of basis items depending from at least one of the respective set of iterators, the respective set of symbols, and the one or more schedule primitives;
and
each weak row solution is a respective linear combination comprising one or more basis items of the respective plurality of basis items.

10. The method of claim 8 wherein:
each of the first schedule and the second schedule has a respective schedule rank associated thereto;
and
the method further comprises, by the computing device:
updating, for at least one of the first schedule and the second schedule, when the respective strong row solution is determined for the at least one dimension of the plurality of dimensions and when the respective strong row solution increases the respective schedule rank, the respective statement basis in accordance with the respective strong row solution.

11. The method of claim 9 further comprising, by the computing device:
each of the first schedule and the second schedule has a respective schedule rank associated thereto;
and
updating, for at least one of the first schedule and the second schedule, when the respective weak row solution is determined for the at least one dimension of the plurality of dimensions and when the respective weak row solution increases the respective schedule rank, the respective statement basis in accordance with the respective weak row solution.

12. The method of claim 8 wherein:
each of the first schedule and the second schedule has a respective schedule rank associated thereto;
each basis item of the respective statement basis of the first statement and the second statement has associated thereto a respective position of a plurality of positions in the respective statement basis, the plurality of positions extending from a beginning of the respective statement basis to an end of the respective statement basis;
and
the method further comprises, by the computing device:
removing, for at least one of the first schedule and the second schedule, when the respective strong row solution is determined for the at least one dimension of the plurality of dimensions and when the respective strong row solution increases the respective schedule rank, one basis item of the respective statement basis from the respective statement basis, the position of the one basis item corresponding to the increased respective schedule rank;
and
inserting, for at least one of the first schedule and the second schedule, when the one basis item of the respective statement basis is removed, a new basis item into the respective statement basis in accordance with the respective strong row solution, the new basis item having associated thereto a position in the respective statement basis corresponding to the beginning of the respective statement basis.

13. The method of claim 9 wherein:
each of the first schedule and the second schedule has a respective schedule rank associated thereto;
each basis item of the respective statement basis of the first statement and the second statement has associated thereto a respective position of a plurality of positions in the respective statement basis, the plurality of positions extending from a beginning of the respective statement basis to an end of the respective statement basis;
and
the method further comprises, by the computing device:
removing, for at least one of the first schedule and the second schedule, when the respective weak row solution is determined for the at least one dimension of the plurality of dimensions and when the respective weak row solution increases the respective schedule rank, one basis item of the respective statement basis from the respective statement basis, the position of the one basis item corresponding to the increased respective schedule rank;
and
inserting, for at least one of the first schedule and the second schedule, when the one basis item of the respective statement basis is removed, a new basis item into the respective statement basis in accordance with the respective weak row solution, the new basis item having associated thereto a position in the respective statement basis corresponding to the beginning of the respective statement basis.

14. The method of claim 8 wherein, for each of the first statement and the second statement, the respective plurality of basis items includes each known row of the respective plurality of rows.

15. The method of claim 9 wherein, for each of the first statement and the second statement, the respective plurality of basis items includes each known row of the respective plurality of rows.

16. The method of claim 1 wherein:
the computer program includes one or more iterators and one or more symbols;
each of the first statement and the second statement includes a respective set of iterators from the one or more iterators and a respective set of symbols from the one or more symbols;
each of the first statement and the second statement has associated thereto a respective statement basis comprising a respective plurality of basis items depending from at least one of the respective set of iterators, the respective set of symbols, and the one or more schedule primitives;
and
the method further comprises, by the computing device:
determining, for the first schedule, a respective schedule rank in accordance with the statement basis of the first statement and, for the second schedule, a respective schedule rank in accordance with the statement basis of the second statement.

17. The method of claim 1 wherein at least one schedule modification defined by one of the one or more schedule primitives is for one of fusing, skewing, distributing, tiling, reordering, and strip mining.

18. The method of claim 1 wherein each of the first schedule and the second schedule are represented by a respective affine function.

19. A computing device comprising a processor coupled to tangible, non-transitory processor-readable memory, the memory having stored thereon instructions to be executed by the processor to implement a method comprising:
receiving a computer program having a first statement and a second statement, the second statement having a dependency on the first statement, the first statement having associated thereto a first schedule, the second statement having associated thereto a second schedule, the first schedule and the second schedule each having a respective plurality of rows, each plurality of rows corresponding to a same plurality of dimensions;
receiving one or more schedule primitives each defining a respective schedule modification;
modifying, in accordance with the one or more schedule primitives, the first schedule and the second schedule so that each row of the respective plurality of rows is either known or unknown, each known row being either constant or variable;
determining, for at least one dimension of the plurality of dimensions:
when the corresponding row of at least one plurality of rows is unknown,
when a next row of each plurality of rows is known and constant, the next row of each plurality of rows corresponding to a next dimension of the plurality of dimensions,
and
when the next row of the plurality of rows of the first schedule is lexically greater than the next row of the plurality of rows of the second schedule,
a respective strong row solution for each unknown corresponding row of the first schedule and the second schedule, the strong row solutions strongly satisfying the dependency of the second statement for the at least one dimension;
and
generating an executable code from the computer program in accordance with each of the first schedule and the second schedule.

20. A tangible, non-transitory processor-readable memory having stored thereon instructions to be executed by a processor to implement a method comprising:
receiving a computer program having a first statement and a second statement, the second statement having a dependency on the first statement, the first statement having associated thereto a first schedule, the second statement having associated thereto a second schedule, the first schedule and the second schedule each having a respective plurality of rows, each plurality of rows corresponding to a same plurality of dimensions;
receiving one or more schedule primitives each defining a respective schedule modification;
modifying, in accordance with the one or more schedule primitives, the first schedule and the second schedule so that each row of the respective plurality of rows is either known or unknown, each known row being either constant or variable;
determining, for at least one dimension of the plurality of dimensions:
when the corresponding row of at least one plurality of rows is unknown,
when a next row of each plurality of rows is known and constant, the next row of each plurality of rows corresponding to a next dimension of the plurality of dimensions,
and
when the next row of the plurality of rows of the first schedule is lexically greater than the next row of the plurality of rows of the second schedule,
a respective strong row solution for each unknown corresponding row of the first schedule and the second schedule, the strong row solutions strongly satisfying the dependency of the second statement for the at least one dimension;
and
generating an executable code from the computer program in accordance with each of the first schedule and the second schedule.
